(19) United States
(12) Patent Application Publication
(10) Pub. No.: US 2007/0181006 A1
(43) Pub. Date: Aug. 9, 2007

(54) Apparatus for roasting fowl and the like

(75) Inventor: Ty Measom, Logan, UT (US)

Correspondence Address: ZIMMERMAN & CRONEN, LLP, 1330 BROADWAY, SUITE 710, OAKLAND, CA, 94612-2506, US

(73) Assignee: Logan Outdoor Products, LLC

(21) Appl. No.: 11/346,893

(22) Filed: Feb. 3, 2006

(51) Int. Cl. A47J 37/10

(52) U.S. Cl. 99/345

(57) ABSTRACT

A support for holding a fowl above a roasting pan during the cooking procedure. The support rests on the bottom of the pan, and is also releasably attached to an end wall of the pan to prevent lateral displacement of the fowl during cooking. The support and the fowl mounted thereon may be easily removed from the pan so as to permit accumulated juices or the like to be scraped out of the pan.

### CROSS-REFERENCE TO RELATED APPLICATIONS

Not applicable.

### FEDERALLY FUNDED RESEARCH

Not applicable.

### SEQUENCE LISTING, ETC. ON CD

Not applicable.

### BACKGROUND OF THE INVENTION

1. Field of the Invention

This invention generally relates to apparatus and systems for cooking fowl, such as turkeys and chickens; and is more particularly directed to the combination of a roasting pan and fowl support structure in which the fowl is supported above the pan in optimum position for the roasting or other cooking operation.

2. Description of Related Art

Roasting pans and poultry holders associated with such pans are known in the cooking art. By way of example, roasting pans have been provided with spit holders on opposite end walls and a spit, adapted to impale a fowl and support the same in a generally horizontal position above the pan. Other devices utilize a roasting pan and a hollow vertical tube extending upwardly from a medial portion of the pan on which the fowl is mounted. Such tubes may be provided with apertures along their length so that steam may pass through the tube and flow through the apertures to provide cooking moisture and flavor to the interior of the fowl.

The systems of the prior art have a number of shortcomings which serve as a deterrent to their widespread use. One problem with certain prior art devices is in connection with the shipping or handling of the pan and holder combination. Even when disassembled, the holder, if receivable in the pan, may still increase the depth of the combined parts greater than the depth of the pan itself. Other shortcomings involve connecting the holder to the pan when they are not permanently connected to begin with. Many fowl, such as turkeys, have considerable weight. When the fowl holder is attached to the side walls of the pan, substantial bending stresses are imposed on such walls. Similarly, when attached to the bottom wall of the pan, a bending force is imposed on the pan bottom. Further, many bottom connections present an uneven bottom surface, and prevent gravy or juices accumulating in the pan from being readily scraped out of the pan.

### BRIEF SUMMARY OF THE INVENTION

In accordance with the teachings of the present invention, there is provided a generally conventional roasting pan and a fowl holder for supporting a turkey, chicken, or the like, in a generally vertically inclined position over the pan. The invention is further characterized by the fact that the weight of the turkey is substantially supported by the bottom well of the roasting pan, yet the holder is releasably attached to a wall (preferably an end wall) of the roasting pan.

A further feature of the invention is the nature of the attachment of the holder to a wall of the pan. Slots in a flange on the holder can be engaged with inwardly extending studs on the pan wall, and releasably received against lateral displacement when a web, at right angles to said flange, engages the bottom wall of the pan.

Another feature of the invention is that the pan bottom may be perfectly smooth, and the forward end of the holder on which it is mounted can be repeatedly removed from the pan and reinstalled on the pan during the cooking operation, and/or after the cooking is completed.

### BRIEF DESCRIPTION OF THE DRAWINGS

FIG. 1 is a perspective view of the fowl support or holder of the invention.

FIG. 2 is a perspective view of the fowl support as it is about to be mounted on a roasting pan.

FIG. 3 is an enlarged perspective view illustrating the manner of engagement of the fowl support and the roasting pan.

FIG. 4 is a perspective view of the fowl support operatively connected to the roasting pan.

FIG. 5 is a cross-sectional view taken substantially in the plan indicated by line 5-5 of FIG. 4.

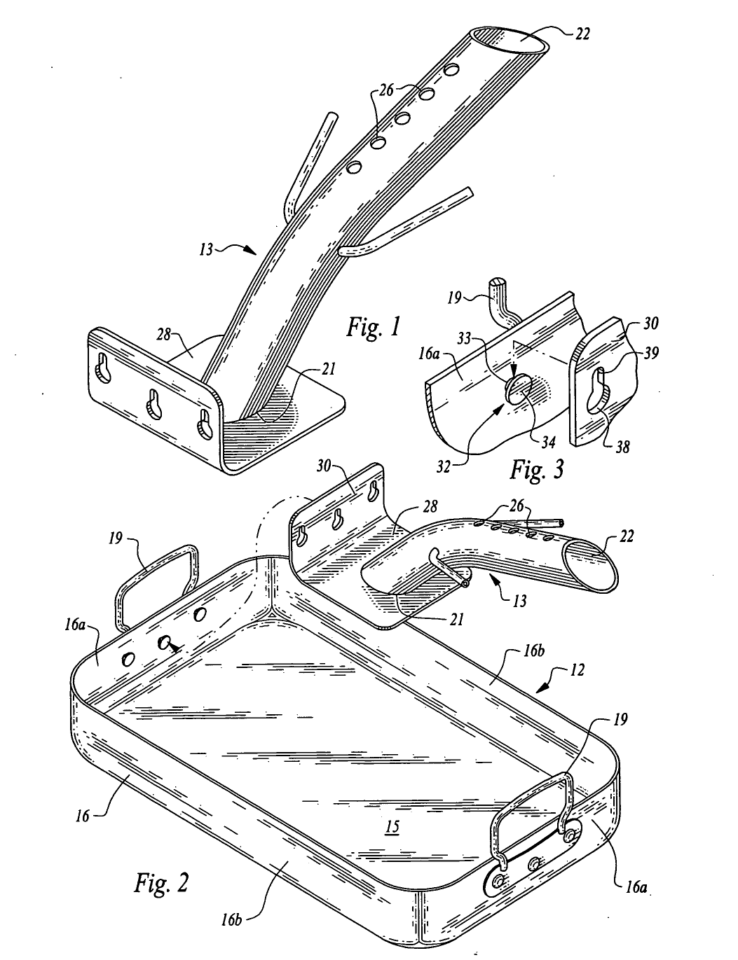

### DETAILED DESCRIPTION OF THE INVENTION

The apparatus of the present invention generally includes two discrete members, namely, a roasting pan 12 and a holder 13 for the fowl or other product (not shown) which is to be cooked.

Pan 12 is preferably, but not necessarily, of generally rectangular configuration, and includes a flat horizontal bottom wall 15 and an integrally formed continuous side wall 16. The side wall can be further described as having end walls 16a and side walls 16b which, together with bottom wall 15, define the generally shallow roasting pan 12. The pan 12 may be provided with handles 19 connected to end walls 16a for ease in moving the pan into and out of the oven.

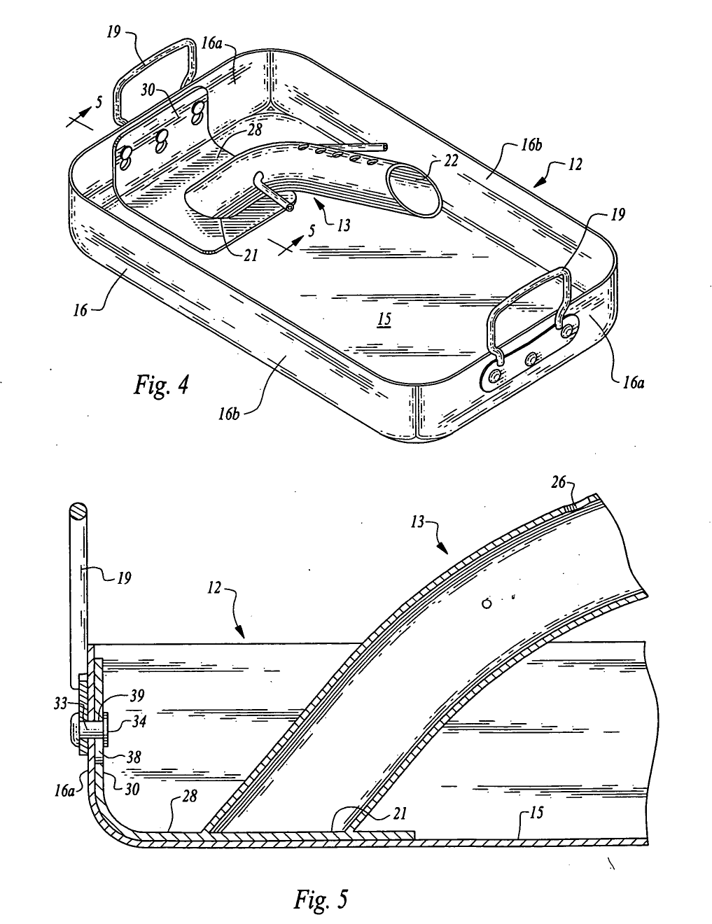

Holder 13 is of generally tubular configuration and includes a proximal end 21 and a distal end 22. The holder is of a generally arcuate configuration along its length, with end 21 cut at an angle relative to the generally longitudinal axis of the holder. Thus, as best shown in FIG. 4, if the proximal end 21 is placed flush with bottom wall 15 adjacent one of the end walls 16a, the distal end 22 of the holder will be positioned generally medially of the pan and spaced above bottom wall 15 of the pan. Accordingly, if a fowl or other object to be cooked is impaled on the holder, such product will be supported above the pan, so that juices produced during the cooking, or basting liquid poured over the product, can gravitally fall into the pan.

The holder may be provided with apertures 26 along its length. Thus, during or prior to the cooking operation, water, beer, wine, broth, or other liquid can be poured into the open end 22 of the holder 13 and the vapors from such liquid resulting from the heat of cooking, will pass through the apertures and moisten or permeate the food product impaled on the holder.

As will be noted, the proximal end of the tubular support is covered by a flat plate, defining a web 28 whose peripheral extent is preferably larger than the diameter of the tubular support. Thus, with the fowl mounted on the support, the weight of the fowl on the bottom wall will not be concentrated over an area defined by the cross-sectional area of the tubular support, but rather an area defined by the size of web 28. Web 28 may be welded or otherwise secured to the proximal end of the tubular support member.

Extending upwardly and at substantially a right angle to web 28 is a vertical flange 30 which is adapted to be releasably attached to end wall 16a in order to retain the holder in the position shown in FIGS. 4 and 5. While various forms of releasable connections may be employed, it is preferable to use the system shown and described herein. As illustrated, the end wall 16a of an otherwise conventional roasting pan is modified by providing one or more projections 32 extending inwardly from said wall. Three of such projections are shown, in order to add to the stability of the structure. Each projection includes a cylindrical stud 33 with an enlarged head 34 at its distal end.

Flange 30 is provided with three openings spaced at the same distance as the spacing between projections 32. Each opening has a lower circular portion 38 with a width larger than the diameter of a corresponding projection head 34. This permits the flange to engage the end wall 16a with the head 34 extending through the same. The opening has an upper slot-like portion 39 of a width greater than the diameter of stud 33, but smaller than the diameter of head 34. Accordingly, the flange may be inserted against the end wall of the pan by having the projection heads 34 entering portion 38 of the flange openings, and then, by lowering the flange until the web 28 engages the bottom wall of the pan, the heads will be engaged in the smaller upper portions 39 of the respective openings and effectively prevent lateral displacement of the fowl supported 13 during cooking.

It is apparent, however, that upon completion of cooking, or if for any reason it is desired to remove the support and the product being cooked, it is only necessary to lift the fowl and the support member 13 upwardly until the projection heads are aligned with the lower portions 38 of the flange openings. The unit may then be released from the projections by moving the same to the right (as shown in FIG. 5) and present a smooth bottom wall on the pan for scraping gravy or other liquids which may be present in the pan.

Although the present invention has been described in connection with the cooking of fowl, it should be understood that the same apparatus can be used for roasting of meat or other food products.

1. (canceled)

2. (canceled)

3. (canceled)

4. Apparatus for cooking fowl, including a pan having a generally flat horizontal bottom wall with a peripheral edge and a generally vertical wall extending upwardly from said peripheral edge of said bottom wall, a fowl support comprising a member on which a fowl may be impaled, a proximate end of said member having a substantially planar web adapted to engage said bottom wall of said pan and a normally related flange adapted to engage said vertical wall of said pan, means releasably connecting said flange to said vertical wall when said web engages said bottom wall, said releasably connecting means includes at least one projection secured to said vertical wall and an opening in said flange for releasably receiving said projection, said at least one projection comprises a stud extending horizontally into said pan spaced from said bottom wall, said stud having a distal end with a radially enlarged head, and said flange opening having a lower portion with a width larger than the width of said stud head, and an upper integral portion of a width larger than the width of said stud and smaller than the width of said stud base.

5. (canceled)

6. Apparatus for cooking fowl, including a pan having a generally flat horizontal bottom wall with a peripheral edge and a generally vertical wall extending upwardly from said peripheral edge of said bottom wall, a fowl support comprising a member on which a fowl may be impaled, a proximate end of said member having a substantially planar web adapted to engage said bottom wall of said pan and a normally related flange adapted to engage said vertical wall of said pan, means releasably connecting said flange to said vertical wall when said web engages said bottom wall, said releasably connecting means includes a plurality of projections horizontally spaced from each other and extending from said vertical wall into said pan in vertically spaced relation to said bottom wall, said flange having a plurality of openings for releasably receiving said projections, each of said projections comprises a stud secured to said vertical wall and a radially enlarged head at the distal end thereof, and each of said flange openings comprising a slot having a lower portion of a width larger than said head so that said flange can be engaged with said vertical wall with said head extending through said lower portion of said slot, said slot having an upper portion of a greater width than the width of said stud but smaller than said head whereby said flange can be moved vertically relative to said wall and when in a lower position will be releasably locked against horizontal displacement.

7. Apparatus as set forth in claim 6 in which said web is adapted to engage said bottom wall when said projections are disposed in said upper portions of said slots.

8. (canceled)

9. (canceled)

1. (canceled)

2. (canceled)

3. (canceled)

4. Apparatus for cooking fowl, including a pan having a generally flat horizontal bottom wall with a peripheral edge and a generally vertical wall extending integrally upwardly from and completely around said peripheral edge of said bottom wall, a fowl support comprising a member on which a fowl may be impaled, a proximate end of said member having a substantially planar web adapted to engage said bottom wall of said pan and a normally related flange adapted to engage said vertical wall of said pan, means releasably connecting said flange to said vertical wall when said web engages said bottom wall, said releasably connecting means includes at least one projection secured to said vertical wall and an opening in said flange for releasably receiving said projection, said at least one projection comprises a stud extending horizontally into said pan spaced from said bottom wall, said stud having a distal end with a radially enlarged head, and said flange opening having a lower portion with a width larger than the width of said stud head, and an upper integral portion of a width larger than the width of said stud and smaller than the width of said stud base, said food support member extending over said bottom wall of said pan.

5. (canceled)

6. Apparatus for cooking fowl, including a pan having a generally flat horizontal bottom wall with a peripheral edge and a generally vertical wall extending upwardly from said peripheral edge of said bottom wall, a fowl support comprising a member on which a fowl may be impaled, a proximate end of said member having a substantially planar web adapted to engage said bottom wall of said pan and a normally related flange adapted to engage said vertical wall of said pan, means releasably connecting said flange to said vertical wall when said web engages said bottom wall, said releasably connecting means includes a plurality of projections horizontally spaced from each other and extending from said vertical wall into said pan in vertically spaced relation to said bottom wall, said flange having a plurality of openings for releasably receiving said projections, each of said projections comprises a stud secured to said vertical wall and a radially enlarged head at the distal end thereof, and each of said flange openings comprising a slot having a lower portion of a width larger than said head so that said flange can be engaged with said vertical wall with said head extending through said lower portion of said slot, said slot having an upper portion of a greater width than the width of said stud but smaller than said head whereby said flange can be moved vertically relative to said wall and when in a lower position will be releasably locked against horizontal displacement, said fowl support member overlying said bottom wall of said pan and having a distal end portion within said peripheral edge.

7. Apparatus as set forth in claim 6 in which said web is adapted to engage said bottom wall when said projections are disposed in said upper portions of said slots.

8. (canceled)

9. (canceled)
